(19) United States
(12) Patent Application Publication
(10) Pub. No.: US 2021/0340683 A1
(43) Pub. Date: Nov. 4, 2021

(54) DEVELOPMENT OF RUTHENIUM-COPPER NANO-SPONGE ELECTRODES FOR AMBIENT ELECTROCHEMICAL REDUCTION OF NITROGEN TO AMMONIA

(71) Applicant: University of Tennessee Research Foundation, Knoxville, TN (US)

(72) Inventors: Feng Yuan Zhang, Tullahoma, TN (US); Kui Li, Tullahoma, TN (US)

(21) Appl. No.: 17/085,720

(22) Filed: Oct. 30, 2020

Related U.S. Application Data
(60) Provisional application No. 63/019,038, filed on May 1, 2020.

(51) Int. Cl. C25B 11/03; C01C 1/00; C25B 11/04; C25B 1/00

(52) U.S. Cl. CPC C25B 11/035; C25B 1/00; C25B 11/0431; C01C 1/00

(57) ABSTRACT

A ruthenium-copper (RuCu) nano-sponge (NSP) electrocatalyst for use in the electrolytic reduction of nitrogen to provide ammonia is described. The RuCu NSP can be prepared as a porous nanoparticle comprising a RuCu alloy via facile reduction of Ru and Cu precursors under ambient conditions. Electrodes prepared with surface disposed RuCu NSPs can be used to prepare ammonia from nitrogen with good yields and Faradaic efficiency at room temperature and atmospheric pressure.

### RELATED APPLICATIONS

The presently disclosed subject matter claims the benefit of U.S. Provisional Patent Application Ser. No. 63/019,038, filed May 1, 2020; the disclosure of which is incorporated herein by reference in its entirety.

### GOVERNMENT INTEREST

This invention was made with government support under Grant No. DE-EE0008426 awarded by the Department of Energy. The government has certain rights in the invention.

### TECHNICAL FIELD

The presently disclosed subject matter relates to ruthenium-copper nano-sponge materials and their use as catalysts in the production of ammonia.

### ABBREVIATIONS

° C.=degrees Celsius
%=percentage
μg=microgram
μL=microliter
μm=micrometer
3D=three-dimensional
A=ampere
Ag=silver
Ar=argon
atm=atmosphere
Au=gold
ccm=cubic centimeters per minute
CE=counter electrode
cm=centimeter
CO₂=carbon dioxide
Cu=copper
EDS=energy dispersive X-ray spectroscopy
FE=Faradaic efficiency
FFT=fast Fourier transform
g=gram
GDL=gas diffusion layer
h=hour
HAADF=high angel annular dark field
HER=hydrogen evolution reaction
HRTEM=high-resolution transmission electron microscopy
KOH=potassium hydroxide
kV=kilovolt
LSV=linear sweep voltammetry
M=molar
mg=milligram
min=minute
mL=milliliter
mM=millimolar
mV=millivolt
N₂=nitrogen gas
NaBH₄=sodium borohydride
NH₃=ammonia
NHE=normal hydrogen electrode
nm=nanometers
N₂RR=nitrogen reduction reaction
NSP=nano-sponge
PEM=proton exchange membrane
Pd=palladium
PDAB=para-dimethylaminobenzaldehyde
Pt=platinum
RE=reference electrode
Rh=rhodium
RHE=reversible hydrogen electrode
Ru=ruthenium
s=second
sccm=standard cubic centimeters per minute
SCE=standard calomel electrode
SEM=scanning electron microscopy
STEM=scanning transmission electron microscopy
TEM=transmission electron microscopy
UV-Vis=ultraviolet-visible
wt=weight
XRD=x-ray powder diffraction

### BACKGROUND

Ammonia has received much attention as a potential energy storage medium and as an alternative fuel for vehicles, in addition to its use as a component of nitrogen fertilizers in the anhydrous, solution, or salt form. Currently, to provide NH₃ as a commodity chemical, there is a heavy reliance on the industrial Haber-Bosch process to furnish NH₃ from N₂ and natural gas under severe reaction conditions (200-350 atm and 350-550° C.), which consumes 3-5% of the annual natural gas production worldwide, approximating to 1-2% of the global annual energy supply.^{1,2} This industrial process is also responsible for >1% of the global CO₂ emission.^{3, 4}

Accordingly, it is desirable to develop an efficient and environmentally friendly process for N₂ fixation using renewable energy under ambient conditions. For example, electro-hydrogenation of N₂ to NH₃ could provide an alternative to Haber-Bosch process. Recently, efforts have been made to develop electrolytes, electrode materials and different electrochemical membrane reactors to alleviate the thermodynamic requirements and improve the NH₃ formation rate using a heterogeneous electrocatalytic approach.^{5,6}

However, there remains an ongoing need for additional electrocatalysts and associated electrodes for the nitrogen reduction reaction (N₂RR) and for related methods of producing ammonia, particularly for electrocatalysts that are relatively cheap and easy to prepare and that provide high yields under less harsh conditions, such as ambient conditions.

### SUMMARY

In some embodiments, the presently disclosed subject matter provides a method of producing ammonia, the method comprising contacting nitrogen with a source of protons and a source of electrons in the presence of a catalyst comprising a ruthenium-copper (RuCu) nano-sponge (NSP), thereby reducing the nitrogen to produce ammonia. In some embodiments, the RuCu NSP comprises porous nanoparticles comprising a bimetallic alloy of the formula RuₓCu₁₋ₓ, wherein 0.01≤x≤0.5. In some embodiments, 0.1≤x≤0.4. In some embodiments, x is 0.15.

In some embodiments, the contacting is performed in an electrolytic cell, wherein the catalyst is disposed on the surface of a cathode electrode, wherein the electrolytic cell comprises an aqueous electrolyte, and wherein the contacting is performed by: (i) feeding gaseous nitrogen to the electrolytic cell; and (ii) running a current through the electrolytic cell. In some embodiments, the ammonia is produced at an electrode potential between about −1.0 volts (V) and about 0.2 V versus reversible hydrogen electrode (RHE). In some embodiments, the ammonia is produced at an electrode potential between about −0.5 V and about 0.05 V versus RHE. In some embodiments, the ammonia is produced at an electrode potential of about −0.2 V versus RHE.

In some embodiments, the Faradaic efficiency of the catalyst is greater than about 0.5%. In some embodiments, the Faradaic efficiency of the catalyst is about 4.39%. In some embodiments, the aqueous electrolyte comprises between about 0.05 molar (M) and about 2 M potassium hydroxide. In some embodiments, the ammonia is produced at a rate of 20 micrograms per milligram of catalyst per hour (μg mg_{cat}⁻¹ h⁻¹) or greater. In some embodiments, ammonia is produced at a rate of about 26.25 μg mg_{cat}¹ h⁻¹. In some embodiments, the contacting is performed at room temperature and/or atmospheric pressure.

In some embodiments, the presently disclosed subject matter provides a method of preparing a ruthenium-copper (RuCu) nano-sponge (NSP), the method comprising: (a) providing an aqueous solution comprising a ruthenium (Ru) precursor and a copper (Cu) precursor at a predetermined ratio, and (b) contacting the aqueous solution from (a) with an aqueous solution of a borohydride reducing agent, thereby preparing the RuCu nano-sponge. In some embodiments, the borohydride reducing agent is an alkali metal borohydride selected from lithium borohydride, potassium borohydride, and sodium borohydride. In some embodiments, the Ru precursor is a Ru halide. In some embodiments, the Cu precursor is a Cu halide. In some embodiments, the predetermined ratio results in a molar ratio of Ru to Cu of between 99:1 and 1:99.

In some embodiments, the presently disclosed subject matter provides a composition comprising a ruthenium-copper (RuCu) nano-sponge (NSP) comprising a porous nanoparticle comprising a RuCu alloy. In some embodiments, the RuCu NSP comprises a porous nanoparticle comprising RuₓCu₁₋ₓ, where 0.01≤x≤0.50. In some embodiments, 0.1≤x≤0.40. In some embodiments, x is 0.15. In some embodiments, the porous nanoparticle has an average diameter between about 10 nanometers (nm) and about 15 nm.

In some embodiments, the presently disclosed subject matter provides an electrode comprising a composition comprising a ruthenium-copper (RuCu) nano-sponge (NSP).

It is an object of the presently disclosed subject matter to provide methods of producing ammonia, ruthenium-copper (RuCu) nano-sponge (NSP) compositions and related electrodes (e.g. for use in the methods of producing ammonia), and methods of producing the NSP compositions. An object of the presently disclosed subject matter having been stated hereinabove, and which is achieved in whole or in part by the presently disclosed subject matter, other objects will become evident as the description proceeds when taken in connection with the accompanying drawings and examples as best described herein below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the present subject matter will be more readily understood from the following detailed description which should be read in conjunction with the accompanying drawings that are given merely by way of explanatory and non-limiting example, and in which:

FIG. 1A is a schematic drawing of a proton exchange membrane (PEM)-electrolyzer for ammonia synthesis.

FIG. 1B is a graph of the polarization curves (current density measured in ampere per square centimeters (A cm⁻²) versus cell voltage measured in volts (V)) of the PEM-electrolyzer shown in FIG. 1A under different atmosphere conditions: argon (Ar) at 0 cubic centimeters per minute (ccm) (circles), Ar at 200 ccm (stars), and nitrogen gas (N₂) at 200 ccm (squares).

FIG. 2 is a series of scanning electron microscopy (SEM) images (top four images and bottom three images on the left) and a graph (bottom right) of the X-ray powder diffraction (XRD) patterns of metallic and bimetallic nano-sponge (NSP) materials, including copper (Cu) NSP, ruthenium-copper (RuCu) NSPs of varying composition (RuₓCu₁₋ₓ, where x is 0.05, 0.1, 0.15, 0.2, or 0.4) and ruthenium (Ru) NSP materials. The white scale bar in the bottom left corner of each of the SEM images corresponds to 2 micrometers (μm). The composition of the materials in the SEM images of the top row are, from left to right: Cu, Ru_{0.05}Cu_{0.95}, Ru_{0.1}Cu_{0.9}, and Ru_{0.15}Cu_{0.85}. The composition of the materials in the three SEM images on the bottom row are, from left to right: Ru_{0.2}Cu_{0.8}, Ru_{0.4}Cu_{0.6}, and Ru. The XRD patterns in the graph at the bottom right are, from top to bottom: Ru, Ru_{0.4}Cu_{0.6}, Ru_{0.2}Cu_{0.8}, Ru_{0.15}, Cu_{0.85}, Ru_{0.1} Cu_{0.9}, Ru_{0.05}Cu_{0.95}, and Cu.

FIG. 3A is a graph showing the linear sweep voltammetry (LSV) curves of an electrode comprising a surface-disposed catalyst comprising an exemplary ruthenium-copper (RuCu) nano-sponge (NSP), i.e., Ru_{0.15}Cu_{0.85} NSP, in nitrogen gas (N₂)-saturated (solid line) and argon (Ar)-saturated (broken line) 0.1 molar (M) potassium hydroxide (KOH) electrolytes with a scan rate of 5 millivolts per second (mV s⁻¹).

FIG. 3B is a graph showing the chronoamperometry curves (current density (j) measured in milliampere per square cm (mA cm⁻²) versus time measured in hours (h)) of the electrode described for FIG. 3A in 0.1 molar (M) potassium hydroxide (KOH) electrolyte at selected potentials, 0 (squares), −0.1 (circles), −0.2 (upward-pointing triangles), −0.3 (downward-pointing triangles), −0.4 (diamonds), and −0.5 (stars) volts (V) versus reversible hydrogen electrode (RHE).

FIG. 3C is a graph of the ultraviolet-visible (UV-Vis) absorption spectra (absorbance measured in arbitrary units (a.u.) versus wavelength measured in nanometers (nm)) of 0.1 molar (M) potassium hydroxide (KOH) electrolyte from the chronoamperometry studies described in FIG. 3B stained with indophenol indicators after charging for 2 hours (h). Data from the electrolyte from the 0 volts (V) study is provided in squares; data from the electrolyte from the study performed at −0.1 V is provided in upward-pointing triangles; data from the electrolyte from the study performed at −0.2 V is provided in circles; data from the electrolyte from the study performed at −0.3 V is provided in downward-pointing triangles; data from the electrolyte from the study performed at −0.4 V is provides as stars; and data from the electrolyte from the study performed at −0.5 V is provided as diamonds.

FIG. 3D is a graph showing the ammonia (NH₃) yield rates and faradaic efficiencies of the electrode described in FIG. 3A at selected potentials, i.e., 0, −0.1, −0.2, −0.3, −0.4, and −0.5 volts (V) versus reversible hydrogen electrode (RHE). The bars show the NH₃ yield rate measured in micrograms per milligram catalyst per hour (μg mg_{cat}⁻¹ h⁻¹) while the Faradaic efficiency, measured as a percentage (%) is shown in the line graph.

FIG. 3E is a graph showing the ammonia yield rates (microgram per milligram catalyst per hour (4 mg_{cat}⁻¹ h⁻¹) as a function of catalyst composition at 0.2 volts (V) versus reversible hydrogen electrode (RHE). The yield rates are shown for electrodes deposited with catalysts of varying ruthenium (Ru)-copper (Cu) composition, RuₓCu₁₋ₓ, where x is 0, 0.05, 0.1, 0.15, 0.2, 0.4, and 1.

FIG. 3F is a graph of the ammonia (NH₃) yield rates (measured in micrograms per milligram catalyst per hour (μg mg_{cat}⁻¹ h⁻¹) of different solutions after electrolysis for 2 hours. The inset shows the ultraviolet-visible (UV-Vis) absorbance spectra of the electrolytes from different conditions.

FIG. 4A is a graph showing the ultraviolet-visible (UV-Vis) absorbance spectra of the colorimetric hydrazine (N₂H₄) assay in 0.1 molar (M) potassium hydroxide (KOH) electrolyte solutions exposed to an exemplary ruthenium (Ru)-copper (Cu) nano-sponge, Ru_{0.15}Cu_{0.85}, at a potential of −0.2 volts (V) for 2 hours. Hydrazine concentrations were 0 micromolar (μM) (squares); 2 μM (circles); 4 μM (stars); 6 μM (downward-pointing triangles); 8 μM (diamonds); and 10 μM (sideways-pointing triangles).

FIG. 4B is a graph showing the calibration curves (absorbance at 458 nanometers (nm) versus hydrazine concentration (micromolar (μM)) for the colorimetric hydrazine (N₂H₄) assay in 0.1 molar (M) potassium hydroxide (KOH).

FIG. 5A is a graph showing the stability test of an exemplary ruthenium (Ru)-copper (Cu) nano-sponge (NSP) catalyst, i.e., Ru_{0.15}Cu_{0.85}, deposited on an electrode in nitrogen gas (N₂)-saturated 0.1 molar (M) potassium hydroxide at a potential of −0.2 volts (V) versus reversible hydrogen electrode (RHE) under consecutive recycling electrolysis. Each cycle was two hours.

FIG. 5B is a graph of the ammonia (NH₃) yield rates (measured in micrograms per milligram catalyst per hour (μg mg_{cat}⁻¹ h⁻¹); left bar of each pair of bars) and Faradaic efficiencies (measured in percentage (%); right bar of each pair of bars) calculated after each cycle of the stability test described for FIG. 5A.

FIG. 6 is a series of elemental mapping transmission electron microscopy (TEM) mapping images of an exemplary ruthenium (Ru)-copper (Cu) nano-sponge, i.e., Ru_{0.15}Cu_{0.85} NSP. The white scale bar in the lower right-hand corner of each image represents 50 nanometers (nm). The presence of Cu is indicated by the color red in the images on the right. The presence of Ru is indicated by the color green in the images on the bottom.

### DETAILED DESCRIPTION

Electrochemical reduction of nitrogen to ammonia under ambient conditions can provide an alternative to the Haber-Bosch process. The presently disclosed subject matter relates to high-performance electrocatalysts and associated electrodes for the nitrogen reduction reaction (N₂RR). More particularly, the presently disclosed subject matter relates, in some aspects, to bimetallic ruthenium-copper (RuCu) nano-sponge (NSP) catalysts, fabricated with rapid and facile methods. The studies described in the Examples hereinbelow demonstrate, for instance, that RuCu NSP catalysts can catalyze the electrochemical reduction of nitrogen at room temperature and atmospheric pressure. The RuCu NSP catalysts can be prepared with excellent regulation of morphology and can reach a high ammonia yield rate and Faradaic efficiency. Thus, in some embodiments, the presently disclosed subject matter provides a scalable strategy for the development of RuCu catalysts with nano-porous structures for electrochemical ammonia generation.

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, light output, atomic (at) or mole (mol) percentage (%), and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “electrolytic cell” as used herein refers to an electrochemical cell that undergoes a redox reaction when electrical energy is applied to the cell. In some embodiments, the electrolytic cell can have at least three parts or components, a cathode electrode, an anode electrode and an electrolyte. The different parts or components can be provided in separate containers, or they can be provided in a single container. The electrolyte can be an aqueous solution in which ions are dissolved. The electrolyte can also be a molten salt, for example a sodium chloride salt.

Sources of protons (or “proton donors”) can include any suitable substance that is capable of donating protons in an electrolytic cell. Sources of protons include, but are not limited to, hydronium (H₃O⁺), as well as organic or inorganic acids.

The term “nano” as in “nanoparticles” as used herein refers to a structure having at least one region with a dimension (e.g., length, width, diameter, etc.) of less than about 1,000 nm. In some embodiments, the dimension is smaller (e.g., less than about 500 nm, less than about 250 nm, less than about 200 nm, less than about 150 nm, less than about 125 nm, less than about 100 nm, less than about 80 nm, less than about 70 nm, less than about 60 nm, less than about 50 nm, less than about 40 nm, less than about 30 nm or even less than about 20 nm). In some embodiments, the dimension is between about 20 nm and about 250 nm (e.g., about 20, 30, 40, 50, 60, 70, 80, 90, 100, 110, 120, 130, 140, 150, 160, 170, 180, 190, 200, 210, 220, 230, 240, or 250 nm).

In some embodiments, the nano- or microparticles described herein can be approximately spherical. When the particles are approximately spherical, the characteristic dimension can correspond to the diameter of the sphere. In addition to spherical shapes, the particles can be disc-shaped, plate-shaped (e.g., hexagonally plate-like), oblong, polyhedral, rod-shaped, cubic, or can have an irregular shape.

The term “room temperature” as used herein refers to a temperature between about 18° C. and about 25° C. (i.e., about 64.4° F. to about 77° F.), or between about 20° C. and about 25° C. (e.g., about 20, 21, 22, 23, 24, or about 25° C.). In some embodiments, room temperature refers to 22° C. “Ambient” conditions can refer to room temperature and about 1 atmosphere pressure.

### II. General Considerations

Electro-hydrogenation of N₂ to NH₃ has aroused considerable attention for benefits including mild reaction conditions (room temperature and ambient pressure), renewable electric energy, and abundant reaction sources (N₂ and water). One challenge of electrochemical synthesis of NH₃ in an aqueous electrolyte system is that highly active N₂RR electrocatalysts can facilitate hydrogen evolution reaction (HER) as well as N₂RR, resulting in the low NH₃ conversion efficiency and poor selectivity.⁷⁻⁹ This is because the N₂RR involves six-electron charge transfer for one nitrogen molecule production, while the competing HER only requires two electrons to produce one hydrogen molecule and occurs at a redox potential (0 V vs. Normal hydrogen electrode [NHE]), similar to that of N₂RR (0.092 V vs. NHE).^{10, 11} Therefore, efficient catalysts with high Faradaic efficiency for N₂RR are desirable.

To address problems including performance and cost, one aspect of the presently disclosed subject matter relates to the incorporation of a more common transition metal, i.e., Cu, into Ru to form a bimetallic alloy as an approach to enhance the chemical affinity between N₂ molecules and the surface atoms of the catalyst, and to decrease the activation energy of the rate limiting step, thus facilitating nitrogen reduction process on a noble metal-based catalyst.

Accordingly, described herein, one aspect of the presently disclosed subject matter is the preparation of three-dimensional ruthenium-copper (RuCu) porous nano-sponge (NSP) compositions via a one-step NaBH₄ reduction in aqueous solution. The metal composition of the final catalysts is readily modified by varying the ratio of metal precursors, which can influence the electronic effect and the morphology of the as-prepared catalysts. It is demonstrated that N₂RR is indeed possible at room temperature and atmospheric pressure by tuning the bimetallic mole ratio. Benefiting from the nano-porous property and bimetallic composition, RuₓCu₁₋ₓ NSPs can exhibit competitive performance (including ammonia yield rate (r_{NH}_{₃}) and Faradaic efficiency (FE)) compared to the previously reported catalysts.

In some embodiments, the presently disclosed subject matter illustrates a proposed mechanistic effect of Cu on the electroreduction of nitrogen and provides a scalable strategy for the development of a RuCu alloy with a nano-porous structure for electrochemical ammonia generation.

### III. Methods of Producing Ammonia

In some embodiments, the presently disclosed subject matter provides a method of producing ammonia, the method comprising contacting nitrogen with a source of protons and a source of electrons in the presence of a catalyst comprising a RuCu nano-sponge (NSP), thereby reducing the nitrogen to produce ammonia. The bimetallic nano-sponge can comprise a porous three-dimensional structure, such as a porous nanoparticle, comprising or consisting of a RuCu alloy.

In some embodiments, the RuCu NSP is a porous nanoparticle having a diameter of about 100 nm or less (e.g., about 100 nm or less, about 75 nm or less or about 50 nm or less). In some embodiments, the nanoparticle has a diameter of about 25 nm or less (e.g., between about 5 nm and about 25 nm). In some embodiments, the nanoparticle has a diameter of about 10 nm to about 15 nm (e.g., about 10, 11, 12, 13, 14, or about 15 nm).

In some embodiments, the nanoparticle comprises a porous structure comprising a bimetallic alloy of the formula RuₓCu₁₋ₓ, wherein 0.01≤x≤0.5. In some embodiments, x is at least about 0.05 and less than about 0.5. In some embodiments, 0.1≤x≤0.4. Thus, for example, x can be about 0.1, 0.15, 0.2, 0.25, 0.3, 0.35, or about 0.4. In some embodiments, x is 0.15.

In some embodiments, the contacting is performed in an electrolytic cell. The electrolytic cell can include at least two electrodes, i.e., a cathode and an anode, with at least one electrolyte disposed between said at least two electrodes. In some embodiments, the electrolytic cell comprises an aqueous electrolyte, such as water or an aqueous solution of an alkali metal hydroxide (e.g., LiOH, NaOH, or KOH). In some embodiments, the RuCu NSP catalyst is disposed (i.e., arranged or present) on a surface of the cathode electrode. For example, in some embodiments, the catalyst can be deposited or coated on the surface of the cathode, optionally along with one or more other components, such as an ionomer or other material that does not impede access to the RuCu NSP from molecules or ions dissolved in an electrolyte surrounding the cathode.

In some embodiments, the contacting is performed by: (i) feeding gaseous nitrogen to the electrolytic cell; and (ii) running a current through the electrolytic cell. Running a current through the electrolytic cell is achieved by applying a voltage to the cell and can lead to a chemical reaction in which nitrogen reacts with protons (created when water in the electrolyte is oxidized at the anode to form hydronium ions) and is reduced to form ammonia. Thus, in some embodiments, the method for producing ammonia comprises: feeding gaseous nitrogen to an electrolytic cell, where it comes in contact with a cathode electrode surface, wherein said surface has a catalyst surface comprising a catalyst comprising a RuCu NSP, said electrolytic cell comprising a proton donor; and running a current through said electrolytic cell, whereby nitrogen reacts with protons to form ammonia.

In some embodiments, the electrolytic cell is configured such that at least one surface the cathode is (or is in contact with) a gas diffusion layer (e.g., a carbon paper layer) that is in contact with an aqueous electrolyte solution in which nitrogen gas is dissolved. In some embodiments, at least one surface of the anode is or is in contact with a gas diffusion layer (GDL) (e.g., a porous metal sheet, such as a Ti felt) that is in contact with an aqueous electrolyte. In some embodiments, a proton exchange membrane (PEM), such as an ionomer membrane (i.e., a synthetic polyelectrolyte membrane, such as a sulfonated tetrafluoroethylene-based fluoropolymer-copolymer sold under the tradename NAFION™ (The Chemours Company, Wilmington, Del., United States of America) is disposed between the anode and the cathode such that at least one surface of the anode and one surface of the cathode are in contact with the same ionomeric membrane. In some embodiments, the electrolytic cell further comprises at least one gas inlet (e.g., nitrogen gas) and at least one gas outlet (e.g., for the ammonia produced in the cell, excess nitrogen, etc.). In some embodiments, the electrolytic cell further comprises at least one liquid inlet (e.g., for addition of aqueous electrolyte) and at least one liquid outlet. In some embodiments, the at least one gas inlet and at least one gas outlet are configured in contact with the electrolyte that is in contact with the GDL that is part of or in contact with the cathode. In some embodiments, the at least one liquid inlet and the at least one liquid outlet are configured in contact with an electrolyte that is in contact with the gas diffusion layer that is part of or in contact with the anode.

In some embodiments, the cathode and anode are porous. For example, the electrodes can be prepared from porous membranes or sheets. Suitable porous membranes or sheets for use in the electrodes include, but are not limited to, macro- or micro- or nano-porous metal-based membranes, such as a metal or metal oxide in the form of a mesh, foam or wool. In some embodiments, the electrode is prepared from a porous carbon material, such as a carbon cloth, a carbon particle/binder composite, graphene, reduced graphene oxide or a conducting polymer. In some embodiments, the anode comprises titanium (Ti) felt/mesh as the gas diffusion layer and iridium oxide (e.g., IrO₂) as the catalyst layer. In some embodiments, the cathode comprises one or more layers of carbon paper. Typically, the RuCu NSP electrocatalyst of the presently disclosed subject matter is disposed on an outer surface of the cathode, such as by deposition from a solution or suspension of the catalyst, or some other coating or deposition method. However, the electrocatalyst can also be deposited throughout the pores of the cathode.

In some embodiments, the ammonia is produced at an electrode potential between about −1.0 volts (V) and 0.2 V versus reversible hydrogen electrode (RHE). In some embodiments, the ammonia is produced at an electrode potential of between about −0.5 V and about −0.05 V (e.g., about −0.5, −0.45, −0.4, −0.35, −0.3, −0.25, −0.2, −0.15, −0.1, −0.05, 0.0, or about 0.05 V). In some embodiments, the ammonia is produced at an electrode potential of about −0.2 V versus RHE.

In some embodiments, the Faradaic efficiency (FE) of the catalyst is greater than about 0.5%. For example, the FE can be about 1%, about 1.5%, about 2%, about 2.25%, about 2.50%, about 2.75%, about 3%, about 3.25%, about 3.5%, about 3.75%, or about 4% or more. In some embodiments, the FE at least about 3%. In some embodiments, the FE is about 4% or more (e.g., about 4.0%, about 4.1%, about 4.2% or about 4.3% or more). In some embodiments, the Faradaic efficiency of the catalyst is about 4.39%.

In some embodiments, the aqueous electrolyte comprises an alkali metal hydroxide (e.g., KOH, NaOH, LiOH). In some embodiments, the concentration of the alkali metal hydroxide is between about 0.05 molar (M) and about 2 M. In some embodiments, the aqueous electrolyte comprises 0.1 molar (M) potassium hydroxide. Thus, in some embodiments, the electrolyte is alkaline. In some embodiments, a neutral electrolyte can be used, such as, an aqueous solution of a salt such as, but not limited to, NaClO₄, KClO₄, LiClO₄, KSO₄, or NaSO₄.

In some embodiments, the ammonia is produced at a rate of 10 micrograms per hour per milligram of catalyst (μg mg_{cat}⁻¹ h⁻¹) or greater (e.g., about 10, 11, 12, 13, 14, 15, 16, 17, 18, 19, or about 20 μg mg_{cat}⁻¹ h⁻¹ or greater). In some embodiments, the ammonia is produced at a rate of at least about 20, at least about 21, at least about 22, at least about 23, at least about 24, at least about 25, or at least about μg mg_{cat}⁻¹ h⁻¹. In some embodiments, the rate is about 26.25 μg mg_{cat}⁻¹ h⁻¹.

In some embodiments, the contacting is performed at room temperature and/or under atmospheric pressure. Other conditions can also be used. For example, in some embodiments, the contacting can be performed at a temperature higher than room temperature but that is about 90° C. or less.

### IV. Method of Producing an Electrocatalyst

In some embodiments, the presently disclosed subject matter provides a method of preparing an electrocatalyst comprising a RuCu porous nanoparticle, i.e., a RuCu nano-sponge (NSP). In some embodiments, the method comprises providing an aqueous solution of one or more water soluble metal precursors (e.g., metal salts, e.g., metal halides), and contacting the solution with a reducing agent, such as a borohydride reducing agent. In some embodiments, the reducing agent is sodium borohydride (NaBH₄) or another alkali metal borohydride (e.g., LiBH₄ or KBH₄).

In some embodiments, the presently disclosed subject matter provides a method of preparing a NSP comprising an alloy of the formula RuₓCu₁₋ₓ, where 0.01≤x≤0.99 or where 0.01≤x≤0.5. In some embodiments, the method comprises: (a) providing an aqueous solution comprising a Ru precursor and a Cu precursor at a predetermined ratio, and (b) contacting the aqueous solution from (a) with an aqueous solution of a borohydride reducing agent, thereby preparing the RuCu NSP. In some embodiments, the borohydride reducing agent is an alkali metal borohydride. In some embodiments, the reducing agent is LiBH₄, KBH₄, or NaBH₄. In some embodiments, the contacting is performed at room temperature. In some embodiments, the contacting is performed for about 5 to about 15 minutes. In some embodiments, the contacting is performed for about 10 minutes.

Any suitable Ru and Cu precursors can be used. In some embodiments, the Ru and/or Cu precursor comprises a Ru halide and/or a Cu halide. In some embodiments, the Ru precursor is RuCl₃. In some embodiments, the Cu precursor is CuCl₂. Other suitable Cu precursors include CuSO₄.

The chemical composition of the RuCu NSP can be controlled by varying the molar ratio of Ru to Cu in the solution provided in step (a). For example, in some embodiments, the molar ratio is between about 99:1 to about 1:99. In some embodiments, the molar ratio of Ru:Cu is between 1:19 and 1:1. In some embodiments, the ratio of Ru:Cu is about 1:19, about 1:9, about 1.5:8.5, about 1:4, or about 2:3.

### V. Electrocatalyst Compositions, Related Electrodes and Cells

In some embodiments, the presently disclosed subject matter provides a composition comprising a RuCu NSP, wherein said RuCu NSP comprises a porous nanoparticle comprising a RuCu alloy. In some embodiments, the RuCu NSP comprises a porous nanoparticle comprising RuₓCu₁₋ₓ, wherein 0.01≤x≤0.99. In some embodiments, 0.01≤x≤0.50. In some embodiments, x is 0.05, 0.10, 0.14, 0.20, 0.25, 0.30, 0.35, 0.40, 0.45 or about 0.50. In some embodiments, the RuCu NSP comprises or consists of Ru_{0.05}Cu_{0.95}, Ru_{0.1} Cu_{0.9}, Ru_{0.15}Cu_{0.85}, Ru_{0.2}Cu_{0.8}, or Ru_{0.4}Cu_{0.6.}

In some embodiments, 0.1≤x≤0.40. In some embodiments, x is 0.15. Thus, in some embodiments, the RuCu NSP comprises or consists of Ru_{0.15}Cu_{0.85.}

In some embodiments, the RuCu NSP comprises a porous nanoparticle having a diameter of about 100 nm or less (e.g., about 100 nm or less, about 75 nm or less or about 50 nm or less). In some embodiments, the nanoparticle has a diameter of about 25 nm or less (e.g., between about 5 nm and about 25 nm). In some embodiments, the nanoparticle has a diameter of about 10 nm to about 15 nm (e.g., about 10, 11, 12, 13, 14, or about 15 nm).

In some embodiments, the presently disclosed subject matter provides an electrode comprising a RuCu NSP. In some embodiments, the RuCu NSP is disposed (e.g., coated or deposited) on a surface of the electrode. In some embodiments, the electrode is a porous electrode. In some embodiments, the electrode comprises a carbon paper electrode wherein one or more surface of the carbon paper has a layer or coating of the RuCu NSP disposed (i.e., coated or arranged thereon). In some embodiments, the layer or coating of the RuCu NSP further comprises an ionomer, such as an ionomer sold under the tradename NAFION™ (The Chemours Company, Wilmington, Del., United States of America) and/or a carbon powder, such as carbon black.

In some embodiments, the presently disclosed subject matter provides an electrolytic cell comprising an electrode comprising the RuCu NSP where the RuCu NSP is disposed on at least one surface of the electrode. In some embodiments, the cell comprises at least two electrodes, wherein one of the two electrodes comprises the RuCu NSP disposed on at least one surface of the electrode. In some embodiments, the electrolytic cell further comprises one or more electrolytes. In some embodiments, the electrolytic cell comprises a PEM, wherein the electrolytic cell is configured such that the PEM is located between the at least two electrodes. In some embodiments, the electrolytic cell further comprises one or more gas diffusion layers. In some embodiments, the electrolytic cell comprises at least one gas inlet (e.g., for bubbling nitrogen gas in at least one electrolyte solution in the electrolytic cell). In some embodiments, the electrolytic cell comprises at least one gas outlet (e.g. for egress of ammonia produced in the electrolytic cell). In some embodiments, the electrolytic cell further comprises at least one liquid inlet and at least one liquid outlet.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

### Synthesis and Methods

### Example 1a. Synthesis of RuₓCu₁₋ₓ Nano-Sponge

RuCu nano-sponge (NSP) was fabricated by reducing Ru and Cu precursors with an aqueous NaBH₄ solution. Taking Ru_{0.4}Cu_{0.6} NSP as an example, an aqueous solution (10 mL) of 16 mM RuCl₃ and 24 mM CuCl₂ was quickly injected into 50 mL of aqueous NaBH₄ solution (50 mM) under vigorous stirring. The stirring was continued for about 10 min until the entire solution became colorless. Then, the mixture was centrifuged and washed with analytically pure water (sold under the tradename MILLI-Q™ (Merck KGaA, Darmstadt, Germany)) and dried at room temperature. Using a similar method, RuₓCu₁₋ₓ (x=0.05, 0.1, 0.15, and 0.2), pure Ru and pure Cu NSP were fabricated by varying the atomic ratios of Ru/Cu in the feeding solution.

### Example 1b. Physical Characterizations

Scanning electron microscopy (SEM) was performed on a JEOL JSM-6320F scanning electron microscope (JEOL USA, Peabody, Mass., United States of America) with an accelerating voltage of 0.5-30 kV. Transmission electron microscopy (TEM) and scanning transmission electron microscopy (STEM) were performed to analyze the morphology of the catalysts. Aberration-corrected bright-field STEM images and energy dispersive X-ray spectroscopy (EDS) were acquired using a JEOL JEM 2200FS transmission electron microscope/scanning transmission electron microscope (TEM/STEM) (JEOL USA, Peabody, Mass., United States of America) and a Hitachi HF3300 TEM/STEM (Hitachi High-Tech, Schaumburg, Ill., United States of America).

### Example 1c. Preparations of the Working Electrodes

First, 2 mg RuₓCu₁₋ₓ catalyst and 3 mg carbon black were dispersed in a 1 mL diluted ionomer solution containing 500 μL DI water, 450 μL isopropanol and 50 μL of an ionomer sold under the tradename NAFION™ (The Chemours Company, Wilmington, Del., United States of America), which formed a homogeneous suspension after sonication for 30 min. Two types of loading and electrode area were used to prepare electrodes in this study: The small carbon-paper electrodes were prepared by drop-casting the suspension on a piece of carbon paper (0.5≤x≤0.5 cm²), with a total mass loading of 50 μg (of which 40 wt % is metal), which were used for all linear sweep voltammetry and cyclic voltammetry measurements. With the same method of drop-casting, 200 μL of the above catalyst suspension was drop-casted on carbon paper with an area of 1≤x≤1 cm², giving a total mass loading of 1 mg cm⁻² (of which 40 wt % is metal), which was used for all controlled potential electrolysis. All carbon papers were washed by sonication with water, acetone, and methanol in sequence before electrochemical tests.

### Example 1d. Electrochemical Measurements

Prior to N₂RR tests: After being rinsed in water thoroughly, the membranes were immersed in deionized water for future use. Electrochemical measurements were performed using a potentiostat (BioLogic, Willow Hill, Pa., United States of America) with electrochemical cell at room temperature in 0.1 M KOH. The carbon rod and saturated calomel electrode (SCE) were used as counter electrode (CE) and reference electrode (RE), respectively. The linear sweep voltammetry was scanned at a rate of 5 mV s⁻¹. The N₂RR activity of an electrode was evaluated using controlled potential electrolysis in an electrolyte for 2 h at room temperature (˜20° C.). Prior to each electrolysis, the 25 mL electrolyte was saturated with N₂ by N₂ gas with ultra-high purity (99.999%) by bubbling for 30 min. During each electrolysis, the electrolyte was continuously bubbled with N₂ at a flow rate of 60 sccm and was agitated with a stirring bar at a stirring rate of ˜600 rpm. No in-line acid trap was used to capture NH₃ that might escape from the electrolyte in the study, as no apparent NH₃ was detected in the acid trap under the experimental conditions used. The applied potentials were non iR-compensated, and the reported current densities were normalized to geometric surface areas.

### Example 1e. Calibration of the Reference Electrodes

All potentials in this study were converted to the reversible hydrogen electrode (RHE) scale via calibration. The calibration was performed using Pt wire as both working electrode and counter electrode in H₂-saturated electrolyte. Cyclic voltammograms were acquired at a scan rate of 1 mV s⁻¹. The two potentials at which the current equaled zero were averaged and used as the thermodynamic potential for the hydrogen electrode reactions.

### Example 1f. Ammonia Quantification

The produced NH₃ was quantitatively determined using the indophenol blue method.²¹ Typically, 2 mL of the sample solution was first pipetted from the post-electrolysis electrolyte. Afterwards, 2 mL of a 1 M KOH solution containing salicylic acid (5 wt %) and sodium citrate (5 wt %) was added, and 1 mL of NaClO solution (0.05 M) and 0.2 mL of sodium nitroferricyanide solution (1 wt %) were added subsequently. After 2 h, the absorption spectra of the resulting solution were acquired with an ultraviolet-visible (UV-Vis) spectrophotometer sold under the tradename SYNERGY™ H1 Hybrid Multi-Mode Reader (BioTek Instruments, Inc., Winooski, Vt., United States of America). The formed indophenol blue was measured by absorbance at λ=667 nm. In order to quantify the produced NH₃, the calibration curves were built using standard NH₄Cl solutions in the presence of 0.1 M KOH to consider the possible influence of different pH values. The measurements with the background solutions (no NH₃) were performed for all experiments, and the background peak was subtracted from the measured peaks of N₂RR experiments to calculate the NH₃ concentrations and the Faradaic efficiencies.

### Example 1g. Hydrazine Quantification

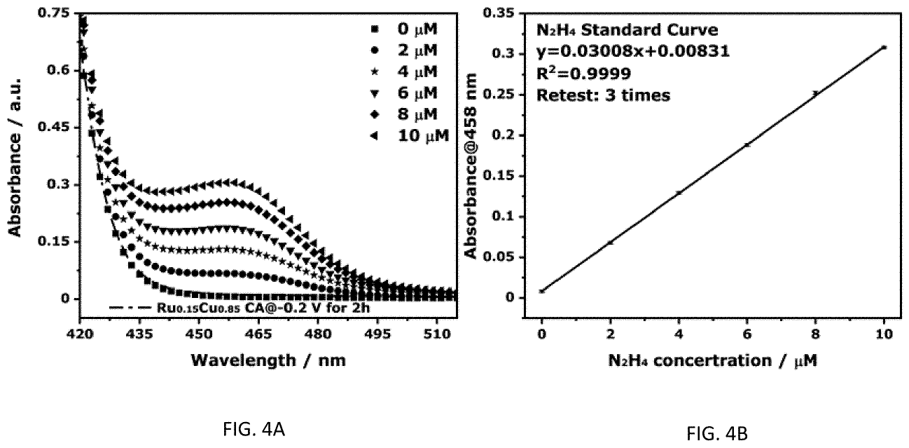

Yellow color developed upon the addition of para-dimethylaminobenzaldehyde (PDAB) to solutions of N₂H₄ in dilute hydrochloric acid solution was used as the basis for the spectrophotometric method to quantify the N₂H₄ concentration²². Typically, 5 mL of the electrolyte solution was taken out and then mixed with 5 mL of the coloring solution (4 g of PDAB dissolved in 20 mL of concentrated hydrochloric acid and 200 mL of ethanol). After 15 min, the absorption spectra of the resulting solution were acquired using a UV-Vis spectrophotometer sold under the tradename SYNERGY™ H1 Hybrid Multi-Mode Reader (BioTek Instruments, Inc., Winooski, Vt., United States of America). Solutions of N₂H₄ with known concentrations in 0.1 M KOH were used as calibration standards, and the absorbance at λ=458 nm was used to plot the calibration curve as shown in FIG. 4B.

### Example 1h. Calculation of the Faradaic Efficiency and the Yield Rate

The Faradaic efficiency (FE) was estimated from the charge consumed for NH₃ production and the total charge passed through the electrode:

Faradaic efficiency=(3F×c_{NH}_{₃}×V)÷Q

The yield rate of NH₃ can be calculated as follows:

Yield rate=(17c_{NH}_{₃}×V)÷(t×m)

where F is the Faraday constant (96,485 C mol⁻¹), c_{NH}_{₃} is the measured NH₃ concentration, V is the volume of the electrolyte, Q is the total charge passed through the electrode, t is the electrolysis time (2 h), and m is the metal mass of the catalyst based on the weight difference close to 0.4 mg. The reported NH₃ yield rate, Faradaic efficiency, and error bars were determined based on the measurements of three separately prepared samples under the same conditions.

### Example 2

### Discussion

There are two main reaction pathways, dissociative (a) and associative (b) mechanisms, during ammonia synthesis. In the former, the N≡N bond is broken into nitrogen atoms on catalyst surfaces before the addition of hydrogen. In the latter, the N≡N bond of the nitrogen molecule is broken simultaneously with the addition of hydrogen. The mechanisms for each step were listed following:

$$\begin{matrix}* + {N}_{2} \to * {N}_{2} & ( 1 ) \\ * {N}_{2} + 6 ( {H}^{+} + {e}^{-} ) \to * {N}_{2} H + 5 ( {H}^{+} + {e}^{-} ) & ( 2 ) \\ * {N}_{2} H + 5 ( {H}^{+} + {e}^{-} ) \to * N N {H}_{2} + 4 ( {H}^{+} + {e}^{-} ) & ( 3 a ) \\ * {N}_{2} H + 5 ( {H}^{+} + {e}^{-} ) \to * N H N H + 4 ( {H}^{+} + {e}^{-} ) & ( 3 b ) \\ * NN {H}_{2} + 4 ( {H}^{+} + {e}^{-} ) \to * N + N {H}_{3} + 3 ( {H}^{+} + {e}^{-} ) & ( 4 a ) \\ * {N}_{2} {H}_{2} + 4 ( {H}^{+} + {e}^{-} ) \to * N H N {H}_{2} + 3 ( {H}^{+} + {e}^{-} ) & ( 4 b ) \\ * N + 3 ( {H}^{+} + {e}^{-} ) \to * N H + 2 ( {H}^{+} + {e}^{-} ) & ( 5 a ) \\ * NHN {H}_{2} + 3 ( {H}^{+} + {e}^{-} ) \to * N {H}_{2} N {H}_{2} + 2 ( {H}^{+} + {e}^{-} ) & ( 5 b ) \\ * NH + 2 ( {H}^{+} + {e}^{-} ) \to * N {H}_{2} + ( {H}^{+} + {e}^{-} ) & ( 6 a ) \\ * N {H}_{2} N {H}_{2} + 2 ( {H}^{+} + {e}^{-} ) \to * N {H}_{2} + N {H}_{3} + ( {H}^{+} + {e}^{-} ) & ( 6 b ) \\ * N {H}_{2} + ( {H}^{+} + {e}^{-} ) \to * N {H}_{3} & ( 7 ) \\ * N {H}_{3} \to N {H}_{3} + * & ( 8 )\end{matrix}$$

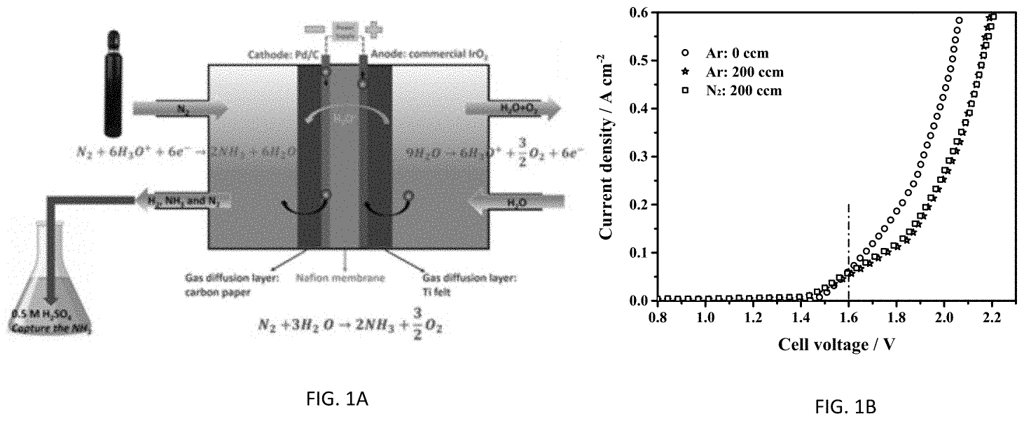

An electrolyzer cell with a proton exchange membrane (PEM) to promote the NH₃ synthesis in scalable application was prepared using a noble metal catalyst (i.e., Pd) at the cathode. The schematic of the cell is shown in FIG. 1A. Polarization curves in different atmospheres are shown in FIG. 1B. The obtained ammonia yield rate and Faradaic efficiency are 1.073 μg mg_{cat}⁻¹ h⁻¹ and 0.07%, respectively, which is so low as to limit commercial application. For the six-electron process of electrochemical NH₃ synthesis, more efficient catalysts with high Faradaic efficiency for nitrogen reduction reaction (N₂RR) are desirable. Theoretical investigations have demonstrated that Ru is one of the most active surfaces for electrochemical ammonia production. However, the high costs and low abundance of Ru restrict the use of Ru catalysts in large-scale applications. To address these issues, introducing Cu into the Ru catalyst can be used as an approach to reduce the amount of Ru.

RuCu NSP were synthesized by NaBH₄ reduction, in which metal precursors were reduced simultaneously at nucleation and growth stages due to the reduction capacity of NaBH₄. The metal composition of the final catalysts is easily modified by varying the Ru/Cu ratio, which can also influence the electronic effects and morphology of the as-prepared catalysts.

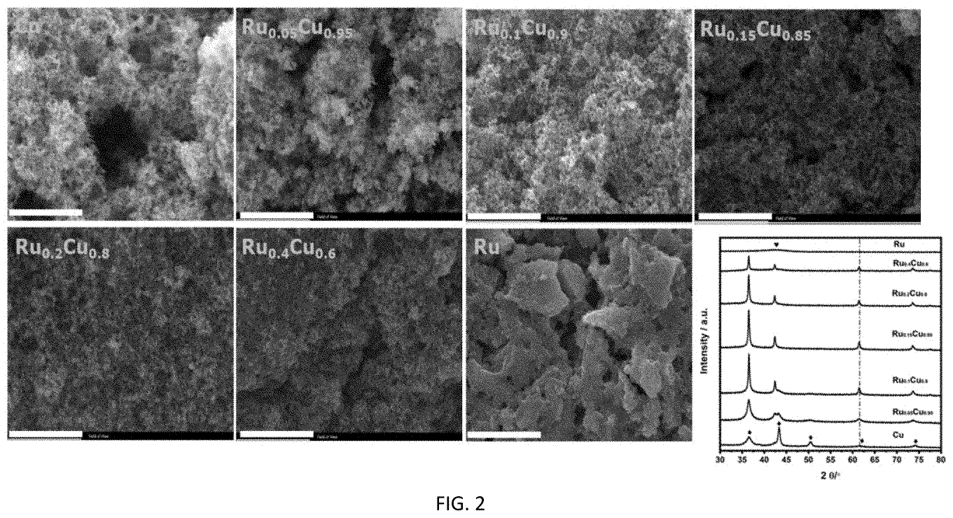

The morphology of the samples was investigated by electron microscopes. As shown in FIG. 2, Cu constituents in the alloy can affect the formation of the NSP structure. The higher the Cu content is, the more uniformly the porous structure spreads. Without being bound to any one theory, one reason for this could be ascribed to the small particle size of Ru, which is more likely to aggregate in aqueous solution, while it prefers to generate interconnected porous networks with Cu under the same conditions. Balancing the morphology effect, the representative SEM image of Ru_{0.15}Cu_{0.85} NSP clearly displays the formation of 3D nano-sponge structure. As shown in the XRD patterns of the samples, the profiles of CuₓRu₁₋ₓ were negatively shifted as the ratio of Ru increased. These results indicated that the formation of Ru—Cu alloy rather than mixed crystals.

According to a high-resolution transmission electron microscope (HRTEM) image, Ru_{0.15}Cu_{0.85} NSP possesses an average size of approximately 10-15 nm with well-defined crystal lattices. An interplanar spacing of 0.242 nm and 0.198 nm was observed in the fast Fourier transform (FFT) patterns of a typical nanoparticle, corresponding to the (111) and (200) facets of the RuCu NSP, respectively. The XRD pattern of the Ru_{0.15}Cu_{0.85} NSP exhibits five diffraction peaks at 36.5°, 42.4°, 61.4°, and 73.6°, which are indexed to (111), (200), (220), and (311) planes of the fcc Ru_{0.15}Cu_{0.85} alloy structure.

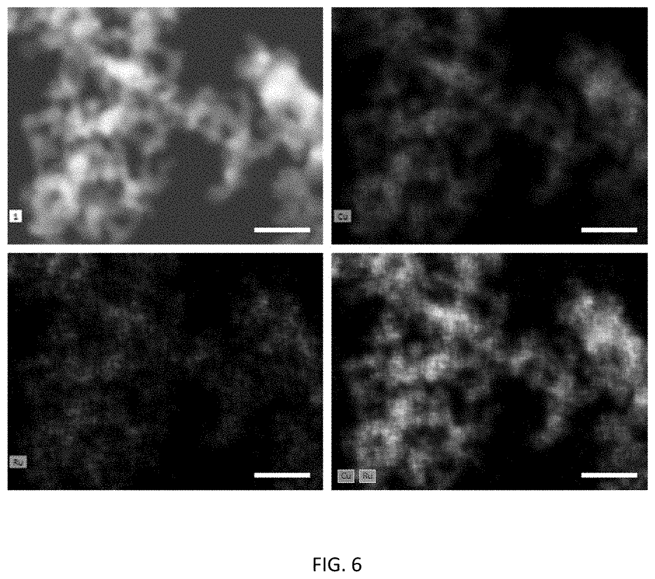

In order to investigate the elemental distribution in the Ru_{0.15}Cu_{0.85} NSP, the high-angle annular dark-field scanning transmission electron microscopy (HAADF-STEM) was performed. The elemental mapping images and compositional line profiles of the Ru_{0.15}Cu_{0.85} NSP reveal that Ru and Cu are uniformly distributed in the product, also suggesting the successful formation of the alloy composition. See FIG. 6.

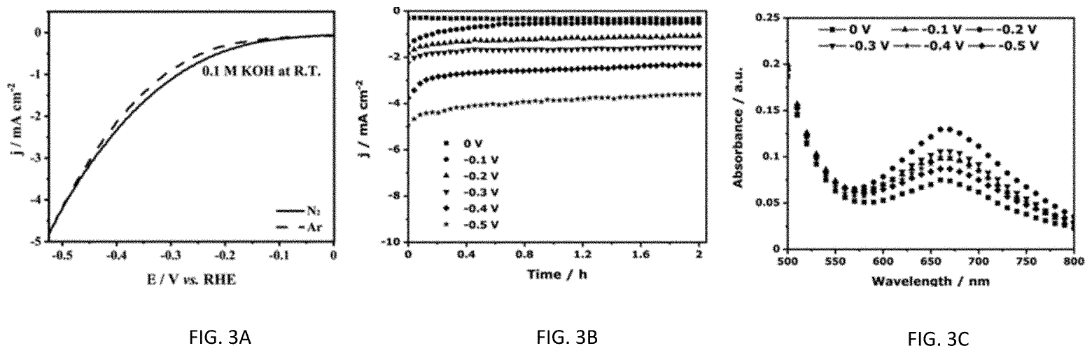

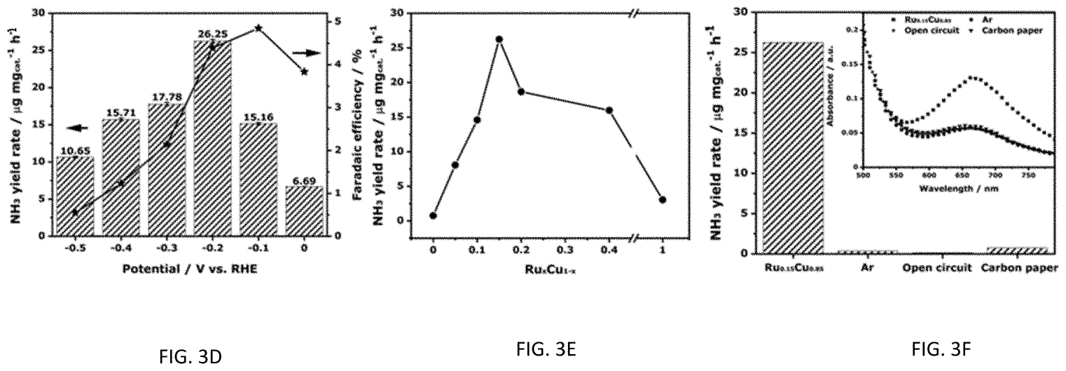

Owing to the porous structure and bimetallic composition, the RuₓCu₁₋ₓ NSP can synergistically activate N₂ and facilitate the mass transfer of nitrogen species. For N₂RR measurements, the N₂ gas was continually bubbled into the cathodic electrolyte, in which N₂ molecules react with electrons and protons to form NH₃ molecules on the cathode catalyst. All potentials are converted to Reversible Hydrogen Electrode (RHE). Firstly, a comparison investigation of linear sweep voltammetry (LSV) curves is performed under Ar- and N₂-saturated 0.1 M KOH, respectively. See FIG. 3A. Under the N₂ atmosphere, there is a distinct enhancement in current density between 0 and −0.5 V, which is ascribed to N₂ reduction to NH₃ catalyzed by RuₓCu₁₋ₓ NSP.

In order to estimate N₂RR performance, chronoamperometric tests were carried out at a series of potentials. Every chronoamperometric curve was almost constant in current density throughout the N₂RR process (see FIG. 3B), indicating a robust long-term stability of the RuₓCu₁₋ₓ NSP for electrocatalysis.

The amount of produced NH₃ in the electrolyte was calculated by UV-Vis spectroscopy. In UV-Vis absorption spectra, discernible absorbance was observed at a wavelength of 667 nm for different electrolytes colored with indophenol indicators (see FIG. 3C), confirming that the electrocatalytic nitrogen reduction to ammonia occurred at selected potentials. The average r_{NH}_{₃} and FE at different potentials were determined based on a calibration curve prepared using control solutions comprising varying concentrations of NH₄Cl.

The relationship between N₂RR performance and applied potential is shown in FIG. 3D, where peak values of produced NH₃ amount and high FE are achieved at −0.2 V, which reach approximately 26.25 μg mg_{cat}⁻¹ h⁻¹ and 4.39%, respectively. As the N₂RR is a N₂ hydrogenation process, the selected potential is susceptible to the N₂RR performance. After the peak value at −0.2 V, the r_{NH}_{₃} and FE decrease gradually due to the competition of hydrogen evolution reaction on RuₓCu₁₋ₓ NSP.

The selectivity of the RuCu NSP electrocatalysts can be confirmed by lack of detection of the byproduct of hydrazine. No hydrazine is detected in each electrolyte (see FIG. 4A), indicating 100% selectivity toward nitrogen reduction to ammonia.

The Ru/Cu stoichiometric ratio was tailored to prepare different Ru—Cu alloy nanostructures and their catalytic activities were measured under the same potential. The difference of N₂RR activity among these Ru—Cu alloys can depend on the tunable structure and composition of bimetals. See FIG. 3E. The Ru_{0.15}Cu_{0.85} NSP provides optimum bimetallic Ru—Cu nanostructures with maximum active sites, leading to a peak value.

To confirm the source of nitrogen in the produced NH₃, three sets of control experiments were designed: (1) RuCu NSP catalyst in an Ar-saturated solution at −0.2 V; (2) RuCu NSP catalyst in a N₂-saturated solution at an open circuit voltage; (3) carbon paper catalyst in a N₂-saturated solution at −0.2 V. For each case, a negligible amount of ammonia is detected (see FIG. 3F), confirming that the detected NH₃ is obtained through the N₂RR in the presence of RuCu NSP catalysts.

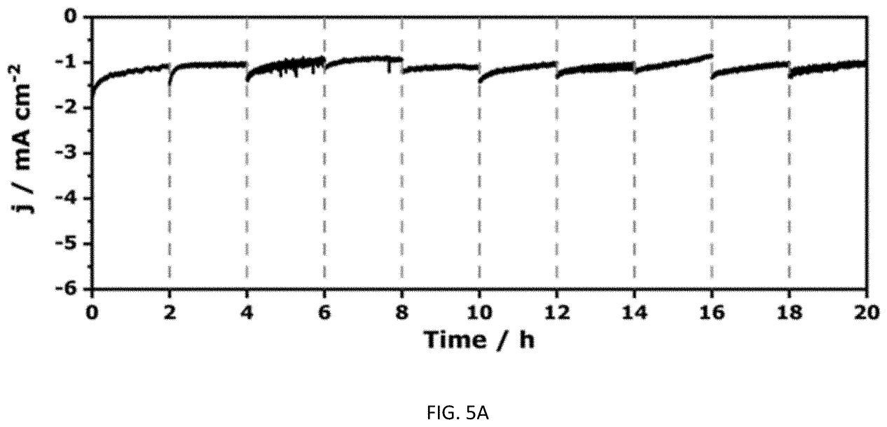

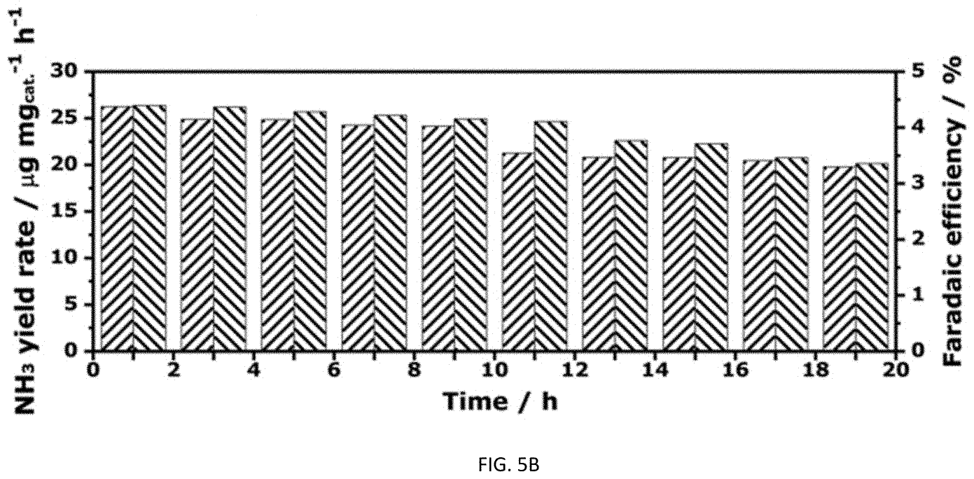

For practical applications, the stability of an electrocatalyst is beneficial for N₂RR. As shown in FIGS. 5A and 5B, the stability of the RuCu NSP catalyst for electrochemical N₂RR was assessed by consecutive recycling electrolysis at −0.2 V. After five consecutive cycles, only about 8% decline in the total current density was observed. Furthermore, the r_{NH}_{₃} and FE decreased to 19.79 μg mg_{cat.}⁻¹ h⁻¹ and 3.35% after ten cycles, indicating a loss of the N₂RR activity by 25% after 20 hours of operation. Without being bound to any one theory, it is believed that this can be caused by the electrocatalyst's collapse from support and the aggregation of particles during the catalytic process. The above-described results indicate the N₂RR stability of the RuCu NSP due to their 3D interconnected porous structure.

In summary, herein is demonstrated electrocatalytic nitrogen reduction to ammonia by bimetallic RuCu porous structures which were very rapidly fabricated by co-reduction of Cu and Ru precursors. The porous structures provide sufficient active sites and present a favorable electronic effect, which can greatly improve the N₂RR activity of the RuCu. The achieved N₂RR yield of 26.25 μg mg_{cat}⁻¹ h⁻¹ is superior to the yields of the monometallic Ru and Cu counterparts. Accordingly, the presently disclosed synthetic method is feasible to prepare porous nanostructures with tunable compositions in a rapid and economical method, which can promote NH₃ production with more convenience and availability.

### REFERENCES

All references listed in the instant disclosure, including but not limited to all patents, patent applications and publications thereof, scientific journal articles, and database entries are incorporated herein by reference in their entireties to the extent that they supplement, explain, provide a background for, and/or teach methodology, techniques, and/or compositions employed herein. The discussion of the references is intended merely to summarize the assertions made by their authors. No admission is made that any reference (or a portion of any reference) is relevant prior art. Applicants reserve the right to challenge the accuracy and pertinence of any cited reference.
1. Liu, H.; Wei, L.; Liu, F.; Pei, Z.; Shi, J.; Wang, Z.-j.; He, D.; Chen, Y., Homogeneous, heterogeneous, and biological catalysts for electrochemical N₂ reduction toward NH₃ under ambient conditions. ACS Catalysis 2019, 9 (6), 5245-5267.
2. Chen, S.; Perathoner, S.; Ampelli, C.; Mebrahtu, C.; Su, D.; Centi, G., Electrocatalytic Synthesis of Ammonia at Room Temperature and Atmospheric Pressure from Water and Nitrogen on a Carbon-Nanotube-Based Electrocatalyst. Angewandte Chemie International Edition 2017, 56 (10), 2699-2703.
3. Rosca, V.; Duca, M.; de Groot, M. T.; Koper, M. T., Nitrogen cycle electrocatalysis. Chemical Reviews 2009, 109 (6), 2209-2244.
4. Smil, V., Enriching the earth: Fritz Haber, Carl Bosch, and the transformation of world food production. MIT press: 2004.
5. Lv, C.; Yan, C.; Chen, G.; Ding, Y.; Sun, J.; Zhou, Y.; Yu, G., An Amorphous Noble-Metal-Free Electrocatalyst that Enables Nitrogen Fixation under Ambient Conditions. Angewandte Chemie International Edition 2018, 0 (0).
6. Yao, Y.; Zhu, S.; Wang, H.; Li, H.; Shao, M., A Spectroscopic Study on the Nitrogen Electrochemical Reduction Reaction on Gold and Platinum Surfaces. Journal of the American Chemical Society 2018, 140 (4), 1496-1501.
7. Wang, H. J.; Li, Y. H.; Li, C. J.; Deng, K.; Wang, Z. Q.; Xu, Y.; Li, X. N.; Xue, H. R.; Wang, L., One-pot synthesis of bi-metallic PdRu tripods as an efficient catalyst for electrocatalytic nitrogen reduction to ammonia. Journal of Materials Chemistry A 2019, 7 (2), 801-805.
8. Schild, D. J.; Peters, J. C., Light Enhanced Fe-Mediated Nitrogen Fixation: Mechanistic Insights Regarding H2 Elimination, HER, and NH₃ Generation. ACS catalysis 2019, 9 (5), 4286-4295.
9. Liu, Y.; Huang, L.; Zhu, X.; Fang, Y.; Dong, S., Coupling Cu with Au for enhanced electrocatalytic activity of nitrogen reduction reaction. Nanoscale 2020, 12 (3), 1811-1816.
10. Skulason, E.; Bligaard, T.; Gudmundsdóttir, S.; Studt, F.; Rossmeisl, J.; Abild-Pedersen, F.; Vegge, T.; Jonsson, H.; Nørskov, J. K., A theoretical evaluation of possible transition metal electro-catalysts for N 2 reduction. Physical Chemistry Chemical Physics 2012, 14 (3), 1235-1245.
11. Deng, J.; Iniguez, J. A.; Liu, C., Electrocatalytic nitrogen reduction at low temperature. Joule 2018, 2 (5), 846-856.
12. Wang, J.; Yu, L.; Hu, L.; Chen, G.; Xin, H. L.; Feng, X. F., Ambient ammonia synthesis via palladium-catalyzed electrohydrogenation of dinitrogen at low overpotential. Nat Commun 2018, 9.
13. Wang, Z.; Li, Y.; Yu, H.; Xu, Y.; Xue, H.; Li, X.; Wang, H.; Wang, L., Ambient Electrochemical Synthesis of Ammonia from Nitrogen and Water Catalyzed by Flower-Like Gold Microstructures. ChemSusChem 2018, 11 (19), 3480-3485.
14. Liu, H.-M.; Han, S.-H.; Zhao, Y.; Zhu, Y.-Y.; Tian, X.-L.; Zeng, J.-H.; Jiang, J.-X.; Xia, B. Y.; Chen, Y., Surfactant-free atomically ultrathin rhodium nanosheet nanoassemblies for efficient nitrogen electroreduction. Journal of Materials Chemistry A 2018, 6 (7), 3211-3217.
15. Skulason, E.; Bligaard, T.; Gudmundsdóttir, S.; Studt, F.; Rossmeisl, J.; Abild-Pedersen, F.; Vegge, T.; Jonsson, H.; Nørskov, J. K., A theoretical evaluation of possible transition metal electro-catalysts for N₂ reduction. Physical Chemistry Chemical Physics 2012, 14 (3), 1235-1245.
16. Wang, Z.; Li, C.; Deng, K.; Xu, Y.; Xue, H.; Li, X.; Wang, L.; Wang, H., Ambient Nitrogen Reduction to Ammonia Electrocatalyzed by Bimetallic PdRu Porous Nanostructures. ACS Sustainable Chemistry & Engineering 2019, 7 (2), 2400-2405.
17. Xiao, M. L.; Feng, L. G.; Zhu, J. B.; Liu, C. P.; Xing, W., Rapid synthesis of a PtRu nano-sponge with different surface compositions and performance evaluation for methanol electrooxidation. Nanoscale 2015, 7 (21), 9467-9471.
18. Zhang, Q.; Kusada, K.; Wu, D. S.; Ogiwara, N.; Yamamoto, T.; Toriyama, T.; Matsumura, S.; Kawaguchi, S.; Kubota, Y.; Honma, T.; Kitagawa, H., Solid-solution alloy nanoparticles of a combination of immiscible Au and Ru with a large gap of reduction potential and their enhanced oxygen evolution reaction performance. Chemical Science 2019, 10 (19), 5133-5137.
19. Wang, G. W.; Li, W. Z.; Wu, N.; Huang, B.; Xiao, L.; Lu, J. T.; Zhuang, L., Unraveling the composition-activity relationship of Pt—Ru binary alloy for hydrogen oxidation reaction in alkaline media. Journal of Power Sources 2019, 412, 282-286.
20. Shan, J. Q.; Guo, C. X.; Zhu, Y. H.; Chen, S. M.; Song, L.; Jaroniec, M.; Zheng, Y.; Qiao, S. Z., Charge-Redistribution-Enhanced Nanocrystalline Ru@IrOx Electrocatalysts for Oxygen Evolution in Acidic Media. Chem 2019, 5 (2), 445-459.
21. Searle, P. L., The berthelot or indophenol reaction and its use in the analytical chemistry of nitrogen. A review. Analyst 1984, 109 (5), 549-568.
22. Watt, G. W.; Chrisp, J. D., Spectrophotometric Method for Determination of Hydrazine. Analytical Chemistry 1952, 24 (12), 2006-2008.

The embodiments disclosed herein are provided only by way of example and are not to be used in any way to limit the scope of the subject matter disclosed herein. As such, it will be understood that various details of the presently disclosed subject matter may be changed without departing from the scope of the presently disclosed subject matter. The foregoing description is for the purpose of illustration only, and not for the purpose of limitation.

What is claimed is:

1. A method of producing ammonia, the method comprising contacting nitrogen with a source of protons and a source of electrons in the presence of a catalyst comprising a ruthenium-copper (RuCu) nano-sponge (NSP), thereby reducing the nitrogen to produce ammonia.

2. The method of claim 1, wherein the RuCu NSP comprises porous nanoparticles comprising a bimetallic alloy of the formula RuₓCu₁₋ₓ, wherein 0.01≤x≤0.5.

3. The method of claim 2, wherein 0.1≤x≤0.4.

4. The method of claim 3, wherein x is 0.15.

5. The method of claim 1, wherein the contacting is performed in an electrolytic cell, wherein the catalyst is disposed on the surface of a cathode electrode, wherein the electrolytic cell comprises an aqueous electrolyte, and wherein the contacting is performed by:
(i) feeding gaseous nitrogen to the electrolytic cell; and
(ii) running a current through the electrolytic cell.

6. The method of claim 5, wherein the ammonia is produced at an electrode potential between about −1.0 volts (V) and about 0.2 V versus reversible hydrogen electrode (RHE).

7. The method of claim 6, wherein the ammonia is produced at an electrode potential between about −0.5 V and about 0.05 V versus RHE.

8. The method of claim 7, wherein the ammonia is produced at an electrode potential of about −0.2 V versus RHE.

9. The method of claim 6, wherein the Faradaic efficiency of the catalyst is greater than about 0.5%.

10. The method of claim 9, wherein the Faradaic efficiency of the catalyst is about 4.39%.

11. The method of claim 5, wherein the aqueous electrolyte comprises between about 0.05 molar (M) and about 2 M potassium hydroxide.

12. The method of claim 1, wherein the ammonia is produced at a rate of 20 micrograms per milligram of catalyst per hour (μg mg_{cat}⁻¹ h⁻¹) or greater.

13. The method of claim 12, where ammonia is produced at a rate of about 26.25 μg mg_{cat}⁻¹ h⁻¹.

14. The method of claim 1, wherein the contacting is performed at room temperature and/or atmospheric pressure.

15. A method of preparing a ruthenium-copper (RuCu) nano-sponge (NSP), the method comprising:
(a) providing an aqueous solution comprising a ruthenium (Ru) precursor and a copper (Cu) precursor at a predetermined ratio, and
(b) contacting the aqueous solution from (a) with an aqueous solution of a borohydride reducing agent, thereby preparing the RuCu NSP.

16. The method of claim 15, wherein the borohydride reducing agent is an alkali metal borohydride selected from lithium borohydride, potassium borohydride, and sodium borohydride.

17. The method of claim 15, wherein the Ru precursor is a Ru halide.

18. The method of claim 15, wherein the Cu precursor is a Cu halide.

19. The method of claim 15, wherein the predetermined ratio results in a molar ratio of Ru to Cu of between 99:1 and 1:99.

20. A composition comprising a ruthenium-copper (RuCu) nano-sponge (NSP), wherein the RuCu NSP comprises a porous nanoparticle comprising a RuCu alloy.

21. The composition of claim 20, wherein the RuCu NSP comprises a porous nanoparticle comprising RuₓCu₁₋ₓ, where 0.01≤x≤0.50.

22. The composition of claim 21, where 0.1≤x≤0.40.

23. The composition of claim 22, where x is 0.15.

24. The composition of claim 20, wherein the porous nanoparticle has an average diameter between about 10 nanometers (nm) and about 15 nm.

25. An electrode comprising the composition of claim 20.
